(19) United States
(12) Patent Application Publication
(10) Pub. No.: US 2013/0075501 A1
(43) Pub. Date: Mar. 28, 2013

(54) FUEL INJECTOR

(71) Applicants: Takao Miyake, Hitachinaka (JP); Ryo Kusakabe, Hitachinaka (JP); Motoyuki Abe, Mito (JP); Masahiro Soma, Hitachi (JP)

(72) Inventors: Takao Miyake, Hitachinaka (JP); Ryo Kusakabe, Hitachinaka (JP); Motoyuki Abe, Mito (JP); Masahiro Soma, Hitachi (JP)

(73) Assignee: Hitachi Automotive Systems, Ltd.

(21) Appl. No.: 13/544,512

(22) Filed: Jul. 9, 2012

(30) Foreign Application Priority Data
Sep. 27, 2011 (JP) 2011-210087

(51) Int. Cl. F02M 51/00

(52) U.S. Cl. 239/585.3

(57) ABSTRACT

Improving the injection fuel mass accuracy of fuel injector, it is necessary to make the fuel injector perform seat valve opening and closing operation quickly. When the shapes of a fixed core and an anchor are optimized to improve the responsiveness of a magnetic flux, it is necessary to ensure a sufficient fuel path area while preventing adhesion by making the adherence phenomenon rarely occur between an end face of the anchor and an end face of the fixed core. A through hole passes through an anchor forming an armature of an electromagnetic fuel injector from a face of the anchor where the anchor faces a fixed core to a back face where the through hole has a large-diameter portion and a small-diameter portion, and the large-diameter portion is located in an upstream part and is offset to the outer periphery with respect to the small-diameter portion.

### BACKGROUND OF THE INVENTION

1. Field of the Invention

The present invention relates to fuel injectors used in an internal combustion engine and, in particular, to a fuel injector that opens and closes a fuel path by an electromagnetically-driven armature.

2. Description of the Related Art

An internal combustion engine is provided with a fuel injection control apparatus performing computation to convert an appropriate fuel mass according to an operating state into an injection time of a fuel injector and driving the fuel injector that supplies fuel. The fuel injector opens and closes a seat valve forming the fuel injector by a magnetic force generated by a current passing through a solenoid provided in the fuel injector and performs fuel injection. The mass of injected fuel is determined mainly by a difference between the pressure of the fuel and the peripheral pressure of a nozzle hole of the fuel injector and the time in which an open state of the seat valve is maintained and the fuel is being injected.

In recent years, from the viewpoint of reducing fuel consumption, the opportunity to perform fuel cut so as not to perform fuel injection when output of the internal combustion engine is not required is increased to reduce fuel consumption, and the frequency of restart of fuel injection is also increased. When fuel injection is restarted, it is necessary to inject low fuel mass corresponding to no load. Moreover, split injection is performed to increase output and enhance exhaust performance. The aim of split injection is to enhance the performance of the internal combustion engine by splitting the fuel necessary for one injection into multiple injections and injecting the fuel at appropriate time points, and it is necessary to reduce the injection fuel mass of each injection.

Furthermore, the size of the internal combustion engine has been reduced to reduce fuel consumption when the internal combustion engine is installed in a vehicle. In this case, since an increase in specific power due to supercharging or the like is required, it is necessary to increase the maximum injection fuel mass without increasing the minimum injection fuel mass or while reducing the minimum injection fuel mass. Therefore, a dynamic range (a value obtained by dividing the maximum injection fuel mass by the minimum injection fuel mass) required for the fuel injector tends to increase.

The fuel injector includes, for example, an anchor with a cylindrical armature, a plunger rod located in the center of the anchor, and a seat valve provided at the tip of the plunger rod. A magnetic gap is provided between an end face of a fixed core having a fuel inlet guiding the fuel to a central portion and an end face of the anchor, and a solenoid coil that supplies a magnetic flux to a magnetic path containing the magnetic gap is provided. The anchor is attracted to the fixed core by a magnetic attractive force generated between the end face of the anchor and the end face of the fixed core by the magnetic flux passing through the magnetic gap to drive the armature, and the seat valve is pulled apart from a valve seat to open a fuel path provided in the valve seat.

In the fuel injector structured as described above, the time from when the end face of the anchor and the end face of the fixed core adhere to each other at a collision face and the magnetic force of the magnetic path disappears till when the anchor is returned to an initial position, that is, the state is restored to a state in which the end face of the anchor and the end face of the fixed core are completely separated from each other and the seat valve is pressed against the valve seat becomes undesirably longer.

One of the causes is that a fluid adherence phenomenon occurs between the end face of the anchor and the end face of the fixed core when the end face of the anchor and the end face of the fixed core start separating from each other and a magnetic attraction gap is gradually widened.

Specifically, the magnitude of a fluid force that makes the anchor adhere to the fixed core is proportional to the moving speed of the anchor and is inversely proportional to the cube of the magnitude of the gap. Since the fuel seldom flows into the gap from the outside because the gap is small immediately after a valve-opened state is switched to a valve closing start state and the anchor moves at an extremely low moving speed due to the inertial mass of the fluid surrounding the anchor, the end face of the anchor and the end face of the fixed core adhere to each other under the influence of the above-described phenomenon.

To prevent this phenomenon, it is important not to inhibit the flow of the fuel that is produced between the end face of the anchor and the end face of the fixed core and around the anchor and to promote the flow.

As the existing technology, the technology of preventing adhesion by making the adherence phenomenon rarely occur by making the end face of the anchor and the end face of the fixed core collide at a collision face which is a partial contact face, the collision face between the end face of the anchor and the end face of the fixed core, to solve the above-described problem is disclosed.

As an example of the existing technology, a fuel injector in which at least one collision section provided in an armature has a width b forming only part of a region in which an end face of a fixed core and an end face of the armature make contact with each other, the width b of the collision section is between 20 and 500 μm, a step section located at a level lower than the collision section has a step bottom, and the step section is located at a level 5 to 15 μm lower than the collision section is known (for example, see JP-A-2007-187167 (hereinafter, Patent Document 1)). In this fuel injector, since at least one of component elements that collide with each other is configured in such a way that a collision face is not undesirably widened by wear after long operating hours after the formation of a wear-resistant surface, the time in which the armature is moved by being attracted by the fixed core and the time in which the armature is released from the attraction of the fixed core and is moved away from the fixed core are maintained virtually constant, and magnetic optimality or fluid pressure optimality is achieved.

As an example of another existing technology, a fuel injector with an anchor having a recessed portion formed in the center of the anchor in a position facing an end of a fuel inlet of a fixed core, projection regions that are formed in an end face of the anchor at intervals in a circumferential direction and come into contact with an end face of the fixed core, recess regions formed in the end face of the anchor in a remaining portion in which the projection regions are not formed, and a plurality of through holes, each having an end with an opening in the recess region and the other end with an opening around a plunger at an end face of the anchor opposite to the fixed core, is known (see, for example, WO 2008/038395 (hereinafter, Patent Document 2)). In this fuel injector, since the fuel flows smoothly around the anchor in a state in which the armature transitions from an open valve position to a valve closing operation, the fuel can be supplied quickly to a gap between the end face of the anchor and the end face of the fixed core, and the anchor can be pulled apart from the fixed core promptly. This makes it possible to shorten the valve closing delay time.

To perform injection of an appropriate amount of fuel from the fuel injector with high accuracy, it is necessary to make the fuel injector perform seat valve opening and closing operation quickly. However, at the time of valve opening and closing of the fuel injector, response delays due to the action of a magnetic flux or fluid cause valve opening and closing operation to be completed at a time point later than a time point at which the fuel injection control apparatus actually desires to open and close the valve.

The following is one way of eliminating the above-described response delays. To reduce the occurrence of response delays of a magnetic circuit, a magnetic path area necessary in the fixed core is ensured and, at the same time, the diameter of a fuel path is widened when the fuel path is located in a region away from a solenoid coil generating a magnetic flux, for example, at the center of the fixed core of the fuel injector. This makes it possible to reduce the cross-sectional area of a region of the fixed core, the region away from the solenoid coil, and make the magnetic circuit more responsive. Moreover, based on the same principles, by disposing a projection provided on a collision face between the anchor and the fixed core on the side where the solenoid coil is located, that is, in a position closer to the outer periphery of the anchor, it is possible to make the magnetic circuit more responsive.

However, to dispose the projection collision face in a position closer to the outer periphery of the anchor as disclosed in Patent Document 1 and divide the projection collision face of the anchor by through holes forming a fuel path as disclosed in Patent Document 2, it is necessary to dispose the through holes forming the fuel path in a position closer to the outer periphery of the anchor. In such a case, the openings of the through holes on the side where the fixed core is located are closed with the fixed core, making it impossible to ensure a sufficient fuel path area.

### SUMMARY OF THE INVENTION

It is an object of the present invention to provide an anchor shape that can ensure a sufficient fuel path area while preventing adhesion by making the adherence phenomenon rarely occur between an end face of an anchor and an end face of a fixed core even when the shapes of the fixed core and the anchor are optimized in such a way as to make a magnetic flux more responsive to make a seat valve of a fuel injector more responsive.

To achieve the above object, in an aspect of the invention, a through hole passing through an anchor forming an armature of an electromagnetic fuel injector from a face of the anchor where the anchor faces a fixed core to a back face is formed in such a way that the through hole has a large-diameter portion and a small-diameter portion, and the large-diameter portion is located in an upstream part and is offset to the outer periphery with respect to the small-diameter portion.

Even when the shapes of the fixed core and the anchor projection collision face are optimized to improve magnetic responsiveness, it is possible to dispose a fuel path in a position closer to the center of the anchor and prevent a reduction of a flow channel area. Moreover, even when a collision face between the anchor and the fixed core is located in a position closer to the outer periphery of the anchor, it is possible to divide the collision face, reduce the adhesion between the fixed core and the anchor, and reduce the valve closing delay time. This makes it possible to improve injection fuel mass accuracy.

### BRIEF DESCRIPTION OF THE DRAWINGS

FIG. 1 is a general sectional view of a fuel injector according to an embodiment of the invention;

FIG. 2 is a detailed sectional view of the fuel injector according to the embodiment of the invention;

FIG. 3 depicts an anchor shape according to the embodiment of the invention;

FIG. 4 is a detailed sectional view of a fuel injector in which the principles of the invention cannot be implemented;

FIG. 5 depicts an anchor shape in which the principles of the invention cannot be implemented;

FIG. 6 is a detailed sectional view of a fuel injector in which the principles of the invention cannot be implemented; and

FIG. 7 is a detailed sectional view of a fuel injector in which the principles of the invention cannot be implemented.

### DESCRIPTION OF THE PREFERRED EMBODIMENTS

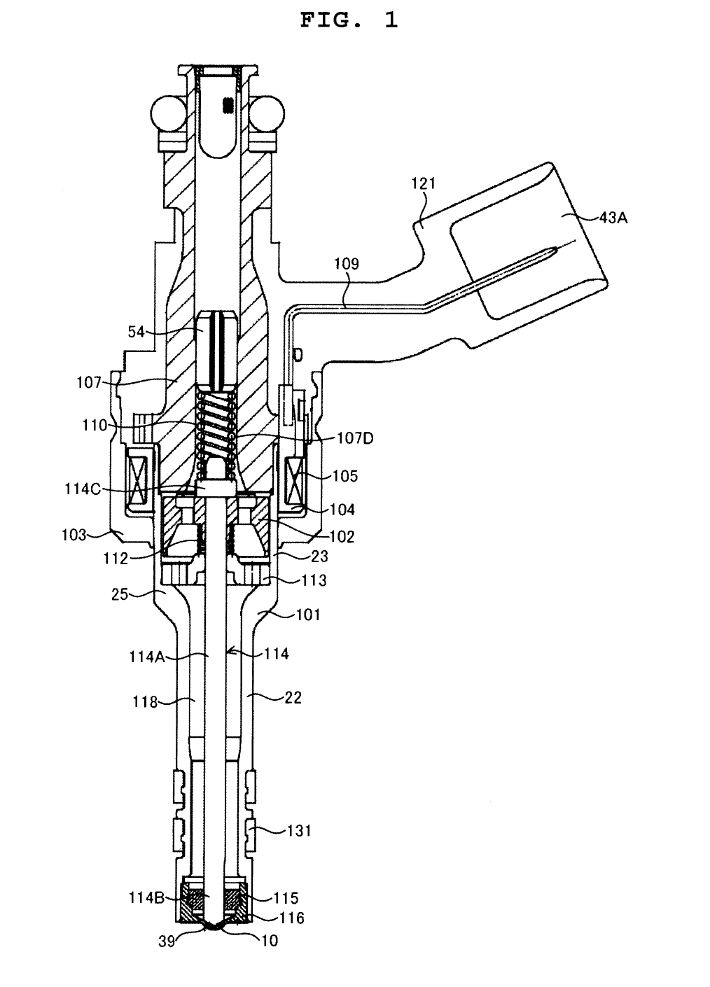

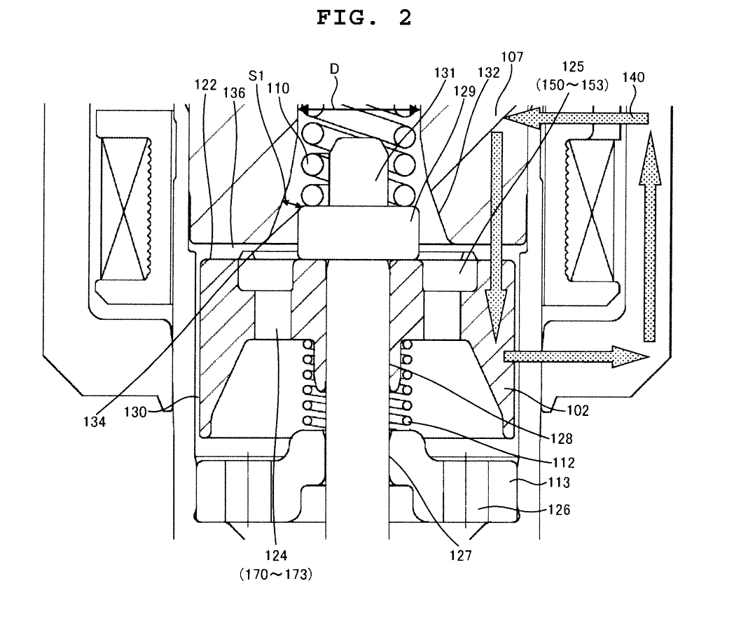

Hereinafter, the structure of an embodiment of a fuel injector according to the invention will be described by using FIGS. 1 to 7. FIG. 1 is a longitudinal sectional view of a fuel injector in this embodiment. FIG. 2 is a partially enlarged view of FIG. 1 and shows the details of the fuel injector in this embodiment.

A nozzle holder 101 includes a small-diameter cylindrical portion 22 with a small diameter and a large-diameter cylindrical portion 23 with a large diameter.

Inside a tip portion of the small-diameter cylindrical portion 22, an orifice cup 116 including a guide member 115 and a fuel orifice 10, which are stacked in this order, is inserted and is welded and fixed to the small-diameter cylindrical portion 22 along a circumference of a tip-end face of the orifice cup 116. The guide member 115 guides the periphery of a seat valve 114B provided at the tip of a plunger rod 114A forming an armature 114 which will be described later. In the orifice cup 116, a conical valve seat 39 is formed on the side facing the guide member 115. The seat valve 114B provided at the tip of the plunger 114A comes into contact with the valve seat 39, and guides the flow of the fuel to the fuel orifice 10 or interrupts the flow of the fuel. A groove is formed around the nozzle holder 101, and a seal member typified by a tip seal 131 made of resin material is fitted into this groove.

At an inner lower end of the large-diameter cylindrical portion 23 of the nozzle holder 101, a rod guide 113 guiding the plunger rod 114A of the armature 114 is press-fitted into a drawn portion 25 of the large-diameter cylindrical portion 23. In the center of the rod guide 113, a guide hole 127 guiding the plunger rod 114A is provided, and a plurality of fuel paths 126 are drilled around the guide hole 127. The long plunger rod 114A is guided by the guide hole 127 of the rod guide 113 and a guide hole of the guide member 115 in such a way as to reciprocate in a straight line.

At an end opposite to the end at which the seat valve 114B of the plunger rod 114A is provided, a head 114C having a stepped portion 129 with an outside diameter larger than the diameter of the plunger rod 114A is provided. In a top end face of the stepped portion 129, a seating face for a spring 110 is provided, and, in the center of the stepped portion 129, a spring guiding protrusion 131 is formed.

The armature 114 has an anchor 102 having, in the center thereof, a through hole 128 through which the plunger rod 114A is placed. Between the anchor 102 and the rod guide 113, a zero spring 112 is held. The zero spring 112 biases the anchor in a valve opening direction, and this biasing force acts on the anchor in a direction opposite to a biasing force generated by the spring 110.

Since the diameter of the through hole 128 is smaller than the diameter of the stepped portion 129 of the head 114C, under action of the biasing force of the spring 110 that presses the plunger 114A against the valve seat 39 of the orifice cup 116 or the gravity, an upper side face of the anchor 102 held by the zero spring 112 makes contact with a lower end face of the stepped portion 129 of the plunger rod 114A, and the upper side face of the anchor 102 and the lower end face of the stepped portion 129 of the plunger rod 114A are in engagement. This makes the upper side face of the anchor 102 and the lower end face of the stepped portion 129 of the plunger rod 114A move in coordination with each other with respect to an upward movement of the anchor 102 against the biasing force of the zero spring 112 or the gravity or a downward movement of the plunger rod 114A along the biasing force of the spring 110 or the gravity. However, the upper side face of the anchor 102 and the lower end face of the stepped portion 129 of the plunger rod 114A can move in different directions when a force moving the plunger rod 114A upward or moving the anchor 102 downward irrespective of the biasing force of the zero spring 112 or the gravity acts on them independently.

The center position of the anchor 102 is held by an inner circumferential surface of the through hole 128 of the anchor 102 and an outer circumferential surface of the plunger rod 114A, not between an inner circumferential surface of the large-diameter cylindrical portion 23 of the nozzle holder 101 and an outer circumferential surface of the anchor 102. That is, the outer circumferential surface of the plunger rod 114A functions as a guide when the anchor 102 moves alone in an axial direction. Although a lower end face of the anchor 102 faces a top end face of the rod guide 113, the lower end face of the anchor 102 does not come into contact with the top end face of the rod guide 113 because the zero spring 112 lies between them. Between the outer circumferential surface of the anchor 102 and the inner circumferential surface of the large-diameter cylindrical portion 23 of the nozzle holder 101, a side gap 130 is provided. The side gap 130 allows an axial movement of the anchor 102, and the size thereof is determined by taking magnetic reluctance into consideration.

A lower end face (a collision end face) of a fixed core 107 and a top end face 122 and collision end faces 160 to 163 of the anchor 102 are sometimes coated with plating to increase durability. Even when relatively soft magnetic stainless steel is used as the material of the anchor 102, it is possible to secure endurance reliability by adopting hard chrome plating or electroless nickel plating.

The fixed core 107 is press-fitted into the large-diameter cylindrical portion 23 of the nozzle holder 101 and is welded and joined to an inner periphery of the large-diameter cylindrical portion 23 in a position in which the fixed core 107 makes contact with the inner periphery of the large-diameter cylindrical portion 23. As a result of the fixed core 107 being welded and joined to an inner periphery of the large-diameter cylindrical portion 23, a gap between the inside of the large-diameter cylindrical portion 23 of the nozzle holder 101 and the outside air is closed. In the center of the fixed core 107, a through hole 107D having a diameter D which is slightly larger than the diameter of the head 114C of the plunger 114A is provided as a fuel inlet path. The head 114C of the plunger rod 114A is placed through the through hole 107D at a lower end portion thereof in such a way that the head 114C does not make contact with the inner periphery of the through hole 107D. Between an inner-periphery lower-end tapered portion 132 of the through hole 107D of the fixed core 107 and an outer edge portion 134 of the stepped portion 129 of the head 114C, a gap S1 is provided to prevent the magnetic flux from leaking from the fixed core 107 to the plunger rod 114A and allow smooth passage of the fuel that has passed through the through hole 107D.

A lower end of the spring 110 for initial load setting makes contact with a spring receiving surface formed in a top end face of the stepped portion 129 provided in the head 114C of the plunger rod 114A. As a result of the other end of the spring 110 being received by an adjuster pin 54 press-fitted into the through hole 107D of the fixed core 107, the spring 110 is fixed between the head 114C and the adjuster pin 54. By adjusting a position in which the adjuster pin 54 is fixed, it is possible to adjust the initial load at which the spring 110 presses the plunger rod 114A against the valve seat 39.

The stroke of the armature 114 is adjusted in the following manner. After the anchor 102 is set in the large-diameter cylindrical portion 23 of the nozzle holder 101 and solenoid coils (104 and 105) and a housing 103 are attached around the large-diameter cylindrical portion 23 of the nozzle holder 101, the plunger rod 114A is pressed by a jig to a valve-closed position in a state in which the plunger rod 114A is placed through the anchor 102, and a position in which the orifice cup 116 is press-fitted is determined concurrently with the detection of the stroke of the plunger rod 114 when the coil 105 is energized. In this way, the stroke of the armature 114 can be adjusted to an arbitrary position.

In a state in which the initial load of the spring 110 is adjusted, a lower end face of the fixed core 107 faces the top end face 122 of the anchor 102 of the armature 114 with a magnetic attraction gap 136 of about 40 to 100 micrometers left between the lower end face of the fixed core 107 and the top end face 122 of the anchor 102. It is to be noted that each component element is enlarged in the drawings without regard for the dimensional ratio thereof.

The cup-shaped housing 103 is fixed around the large-diameter cylindrical portion 23 of the nozzle holder 101. In the center of the bottom of the housing 103, a through hole is provided, and the large-diameter cylindrical portion 23 of the nozzle holder 101 is placed through the through hole. An external wall of the housing 103 forms an outer yoke portion facing an outer circumferential surface of the large-diameter cylindrical portion 23 of the nozzle holder 101. Inside a cylindrical space formed by the housing 103, the ring-shaped or cylindrical solenoid coil 105 is disposed. The solenoid coil 105 is formed of the ring-shaped coil bobbin 104 having a U-shaped cross-sectional groove with an opening facing outward in a radial direction and a copper wire wound around the coil bobbin 104 in the groove. To the ends of the coil 105, a conductor 109 possessing stiffness is fixed and is drawn through a through hole provided in the fixed core 107. The conductor 109, the fixed core 107, and the large-diameter cylindrical portion 23 of the nozzle holder 101 are covered with a resin molded body 121 formed by molding by injection of insulating resin through the opening at the top end of the housing 103. In this way, a toroidal magnetic path indicated by arrows 140 is formed around the solenoid coils (104 and 105).

To a connector 43A formed at the tip of the conductor 109, a plug supplying power from a high-voltage supply and a battery power supply is connected, and an energized/non-energized state is controlled by an unillustrated controller. While the coil 105 is energized, a magnetic attractive force is generated between the anchor 102 of the armature 114 and the fixed core 107 in the magnetic attraction gap 136 by the magnetic flux passing through the magnetic circuit 140, and the anchor 102 moves upward by being attracted by a force exceeding the set load of the spring 110. At this time, the anchor 102 engages the head 114C of the plunger rod and moves upward with the plunger rod 114A until a top end face of the anchor 102 collides with the lower end face of the fixed core 107. As a result, the seat valve 114B located at the tip of the plunger 114A moves away from the valve seat 39, and the fuel passes through a fuel path 118 and squirts into a combustion chamber of an internal combustion engine through the orifice located at the tip of the orifice cup 116.

When the energization of the solenoid coil 105 is stopped, the magnetic flux of the magnetic circuit 140 disappears, and the magnetic attractive force in the magnetic attraction gap 136 also disappears. In this state, the spring force of the spring 110 for initial load setting, the spring force pressing the head 114C of the plunger 114A in an opposite direction, overcomes the force of the zero spring 112 and acts on the entire armature 114 (the anchor 102 and the plunger rod 114A). As a result, the anchor 102 is pushed back by the spring force of the spring 110 to a closed position in which the seat valve 114B makes contact with the valve seat 39. At this time, the stepped portion 129 of the head 114C makes contact with a top face of the anchor 102 and moves the anchor 102 toward the rod guide 113 against the force of the zero spring 112. When the seat valve 114B collides with the valve seat, the anchor 102 continuously moves toward the rod guide 113 by the inertial force since the anchor 102 is provided separately from the plunger rod 114A. At this time, friction is produced by the fluid between the outer periphery of the plunger rod 114A and the inner periphery of the anchor 102, and the energy of the plunger rod 114A that bounces off the valve seat 39 in the valve opening direction again is absorbed. Since the anchor 102 having a high inertial mass is separate from the plunger rod 114A, the bounce-off energy itself is also low. Moreover, since the inertial force of the anchor 102 that has absorbed the bounce-off energy of the plunger rod 114A is decreased by the absorbed inertial force and the repulsive force which the anchor 102 receives after the zero spring 112 is compressed is also decreased, a phenomenon in which the plunger rod 114A is moved in the valve opening direction again by the bounce of the anchor 102 itself rarely occurs. As a result, the bounce of the plunger rod 114A is minimized, preventing a so-called post injection phenomenon in which the valve is opened after the energization of the solenoid coils (104 and 105) is stopped and the fuel is unintentionally ejected.

Here, the fuel injector is required to open and close the valve by quickly responding to an input valve opening signal. That is, from the viewpoint of reducing the minimum controllable fuel mass (the minimum injection fuel mass), it is important to reduce the delay time (the valve opening delay time) between a rising of a valve opening pulse signal and an actual valve-opened state and the delay time (the valve closing delay time) between the end of the valve opening pulse signal and an actual valve-closed state. Above all, it is known that reducing the valve closing delay time is effective in reducing the minimum injection fuel mass. One of the methods for reducing the valve closing delay time is to increase the set load of the spring 110 that provides the armature 114 with a force making the seat valve 114B transition from an open state to a closed state. However, a contradictory situation occurs in which, when this force is increased, a great force is required when the valve is opened and the solenoid coil increases in size. This imposes limitations in design and makes it impossible to reduce the valve closing delay time to a satisfactory extent only by this method.

Various ways to reduce a valve closing delay have been devised, and the following is one of the effective ways to reduce a valve closing delay. When the anchor 102 attracted by the electromagnetic attractive force of the fixed core 107 when a valve is closed is pushed downward by the spring 110, the fuel that has been pushed aside by the movement of the anchor 102 is made to flow into the magnetic gap 136 and the gap (the side gap) 130 on the side of the anchor immediately through the fuel path 118 by using a negative pressure state of the magnetic gap 136 between the lower end face of the fixed core 107 and the top end face 122 of the anchor 102 to reduce the adhesion between the lower end face of the fixed core 107 and the top end face 122 of the anchor 102, the adhesion caused by the squeeze effect. By doing so, it is possible to reduce the valve closing delay time.

As another effective way to reduce a valve closing delay, it is known that the tapered portion 132 is provided at a lower end of the fixed core 107 to reduce a delay in disappearance of the magnetic flux of the magnetic circuit 140 after the energization of the solenoid coils (104 and 105) is ended. In the fixed core 107, by reducing the cross-sectional area of a region on the surface of the through hole 107D of the fixed core at a great distance from the solenoid coils (104 and 105), the region forming the magnetic gap 136 with the anchor, it is possible to reduce the influence of the residual attractive force between the fixed core 107 and the anchor, the residual attractive force generated by a delay in disappearance of the magnetic flux after the end of the energization, and reduce the valve closing delay time.

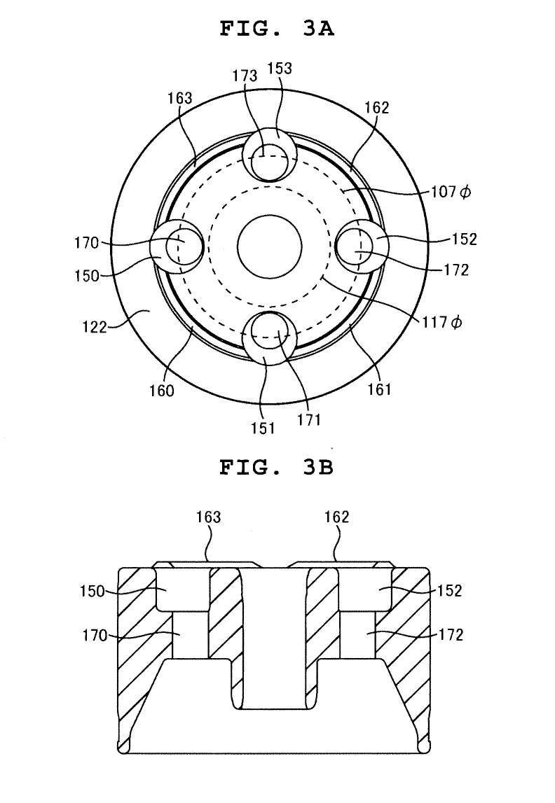

In the publicly-known existing invention, it is impossible to obtain the effects of the above-described two methods at the same time. The present invention proposes the structure of a fuel injector that can be carried out without impairing the effects of the above-described two methods, and the structure will be described in detail by using FIGS. 3 to 7.

In FIG. 3, the details of the anchor 102 in the embodiment are shown. A contact face in the anchor 102, the contact face between the anchor 102 and the fixed core 107, is divided by spot facing holes 150, 151, 152, and 153, and the collision end faces 160, 161, 162, and 163 are formed. The diameter of the spot facing holes 150, 151, 152, and 153 is greater than the diameter of through holes 170, 171, 172, and 173, and the center positions of the spot facing holes 150, 151, 152, and 153 are also offset to the outer periphery of the anchor 102. Incidentally, in the drawing, the depth of the spot facing holes 150, 151, 152, and 153 is enlarged without regard for the dimensional ratio thereof. For example, the depth of the spot facing hole is in the range of 20 to 100 μm from the vertex of a collision projection (a collision end face) located on the side of the anchor 102 where a face thereof facing the fixed core 107 is located.

A broken line 107Φ indicates the inside diameter of the through hole 107D of the fixed core 107. A broken line 117Φ indicates the outside diameter of a spring receiving seat 129 formed in the head 114C of the plunger 114A. When the armature 114 opens the valve, the fuel guided from the through hole 107D of the fixed core 107 to the anchor passes through the fuel path S1 formed between the tapered portion 132 on the inner periphery of the fixed core 107 and the edge of the upper end of the outer periphery of the spring receiving seat 129. Since openings of the spot facing holes 150-153 and the through holes 170-173 following the spot facing holes 150-153 are formed in a downstream part of the fuel path, the fuel flows smoothly. Incidentally, the total of the path cross-sectional areas of the through holes 170-173 is greater than the path cross-sectional area of the fuel path formed by the gap S1. Moreover, the total of the path cross-sectional areas of the through holes 170-173 is greater than the cross-sectional area of the plunger through hole 128. This makes it possible to obtain the fuel path cross-sectional area greater than the fuel path cross-sectional area obtained when a through hole is provided in the plunger. It goes without saying that the fuel path may be further widened by providing a through hole in the center or on the periphery of the plunger 114A while maintaining the structure of the embodiment.

When the armature 114 closes the valve, the fuel that has been pushed aside by the anchor 102 flows through the through holes 170-173 from the fuel path 118 when the magnetic attractive force disappears and the anchor 102 is moved away from the fixed core 107, and flows smoothly into the magnetic gap 136 between the top end face 122 of the anchor 102 and the end face of the fixed core 107, the magnetic gap 136 in which negative pressure is generated.

That is, since projection regions (contact faces) forming the collision end faces 160, 161, 162, and 163 are discontinuous regions, the area of the contact faces necessary for magnetic reasons or impact resistance is ensured and, at the same time, the fuel can move easily into or out of the projection regions (the contact faces). Since the discontinuous regions are located next to the spot facing holes 150-153 and the through holes 170-173 of the anchor 102, the fuel that has been pushed out by the face of the anchor on the downstream side when the valve is closed flows easily to the upstream side of the anchor and is supplied to the projection regions (the contact faces) and the inside and outside thereof. As a result, the force acting in such a way as to make the seat valve 114B adhere to the fixed core 107, the force generated by the squeeze effect, is reduced, and the valve closing delay time is reduced.

As described above, in this embodiment, the spot facing holes 150-153 that are larger than the through holes 170-173 functioning as the fuel path in the anchor 102, the spot facing holes 150-153 whose center positions are offset to the outer periphery of the anchor 102 with respect to the center positions of the through holes 170-173, reduce the adhesion caused by the squeeze effect and reduce a delay in magnetic flux disappearance in the magnetic circuit. This makes it possible to achieve a valve closing delay time shorter than the valve closing delay time in the existing technology and further reduce the minimum controllable fuel mass (the minimum injection fuel mass).

The spot facing holes 150-153 form large-diameter holes located in an upstream part in the through holes passing through the anchor 102 from the top end face thereof (the end face of the anchor 102 on the side facing the fixed core 107) to the lower end face thereof (the end face of the anchor 102 on the side opposite to the fixed core). The through holes 170-173 form small-diameter holes located in a downstream part in the through holes passing through the anchor 102 from the top end face thereof to the lower end face thereof. In this embodiment, the centers of the spot facing holes (large-diameter portions) 150-153 and the centers of the through holes (small-diameter portion) 170-173 are located on a virtual straight line crossing (intersecting) the central axis of the anchor 102 and extending in a radial direction.

Moreover, the top end face 122 of the anchor 102 is formed in such a way that openings of the spot facing holes 150-153 and a part other than the collision end faces 160 to 163 form one flat surface. At this time, the outer edge of the top end face 122, the edge of the opening of the through hole 128, and the edges of the openings of the spot facing holes 150-153 are chamfered and step surfaces formed between the collision end faces 160, 161, 162, and 163 and the top end face 122 are formed as inclined surfaces, and these chamfered portions and inclined surfaces are excluded.

Hereinafter, the difficulty of reducing the adhesion caused by the squeeze effect and reducing a delay in magnetic flux disappearance in the magnetic circuit while ensuring a necessary flow channel area with a structure other than the structure of the invention will be described.

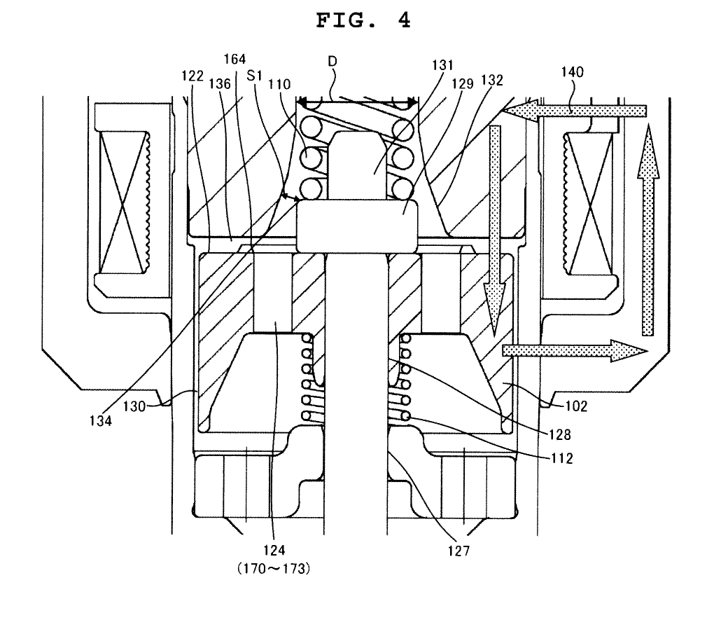

FIG. 4 shows a case in which the spot facing holes 150-153 are not present in the anchor 102. To make the fuel from the fixed core 107 flow smoothly, it is necessary to dispose the through holes 170-173 in such a way that the through holes 170-173 lead to the fuel path S1 formed between the tapered portion 132 on the inner periphery of the fixed core and the edge of the upper end of the periphery of the spring receiving seat 129. On the other hand, a collision face 164 between the fixed core 107 and the anchor 102 is disposed in a position closer to the outer periphery than the tapered portion 132 forming the fuel path. Moreover, it is necessary to increase the area of the magnetic path 140 passing through the housing 103 from the anchor 102 as much as possible to increase the magnetic attractive force at the time of energization of the coil. This makes it difficult to increase the diameter of the through holes 170-173 due to design limitations.

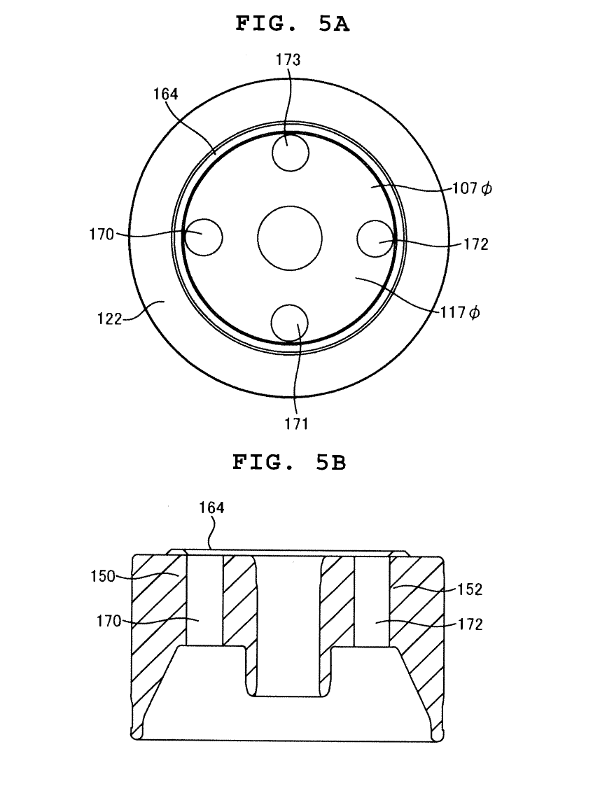

FIG. 5 depicts the shape of the anchor 102 in this case. When there are no spot facing holes, the contact face 164 of the anchor 102 is not divided by the through holes 170-173. This hinders the movement of the fuel inside and outside the projection region (the contact face 164) and makes it impossible to reduce the adhesion caused by the squeeze effect and reduce the valve closing delay time.

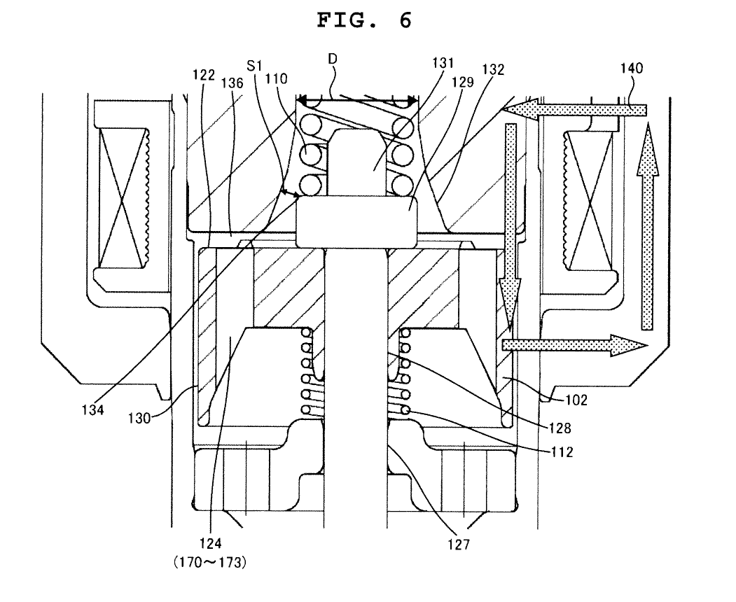

FIG. 6 shows a case in which the through holes 170-173 of the anchor 102 are disposed in positions closer to the outer periphery. Although it is possible to divide the contact face 164 of the anchor 102, the through holes are not disposed in such a way as to lead to the fuel path S1. This prevents a smooth flow of the fuel, hinders the movement of the armature 104, and increases the delay time at the time of valve opening and closing.

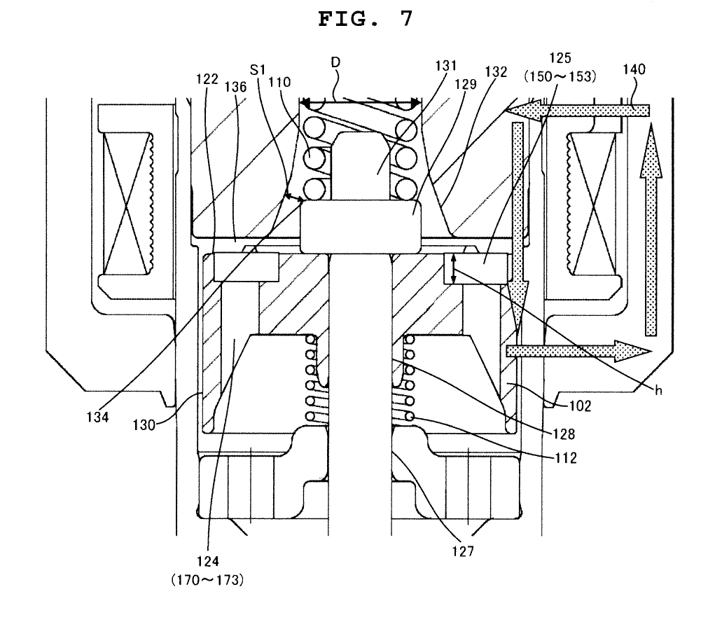

FIG. 7 shows a case in which the center of a spot facing hole 125 is disposed inward as compared to the center of an anchor through hole 124 of FIG. 6. By making the diameter of the spot facing hole 125 greater than the diameter of the through hole 124, it is possible to pass the fuel from the fuel path S1 smoothly through the through hole 124. However, the magnetic attractive force generated by the magnetic circuit 140 decreases as a depth h of the spot facing hole 125 becomes greater. For example, the depth h that can permit a decrease in the attractive force is 20 to 100 μm. Therefore, it is impossible to make an actual spot facing hole as deep as shown in FIG. 7, making it difficult to pass the fuel smoothly though the through hole 124. Moreover, since the through hole 124 is disposed in a position closer to the outer periphery of the anchor, the magnetic path cross-sectional area of the magnetic circuit 140 is reduced, causing a further reduction of the magnetic attractive force.

As described above, when the shape of the invention is adopted, even when the shapes of the fixed core and the anchor projection collision face are optimized to improve magnetic responsiveness, it is possible to dispose the fuel path in a position closer to the center of the anchor and prevent a reduction of the flow channel area. Moreover, even when the collision face between the anchor and the fixed core is located in a position closer to the outer periphery of the anchor, it is possible to divide the collision face, reduce the adhesion between the fixed core and the anchor, and reduce the valve closing delay time. This makes it possible to improve injection fuel mass accuracy.

It is to be noted the invention is not limited to the embodiment described above. Moreover, the component elements are not limited to those described above as long as a characteristic function of the invention is not impaired.

For example, although the fuel used in the fuel injector is not described in detail in the invention, the invention can be applied to all the fuels used in the internal combustion engine, such as gasoline, light oil, and alcohol. This is because the invention has been made based on the viscous drag of fluid. No matter what fuel is used, viscous drag is present. This makes it possible to apply the principles of the invention and produce the advantages thereof. Moreover, in FIGS. 1 to 7 of the embodiment, the circular spot facing hole and through hole are provided in the anchor. However, from the standpoint of the fuel path, the spot facing hole and the through hole are not limited to the circular spot facing hole and through hole. The principles of the invention can be applied to a spot facing hole and a through hole of other shape.

1. A fuel injector comprising:
a cylindrical anchor;
an armature including a plunger rod located in the center of the anchor and a seat valve provided at the tip of the plunger rod;
a fixed core having a fuel inlet guiding fuel to a central portion; and
a solenoid coil supplying a magnetic flux to a magnetic path containing a magnetic gap provided between an end face of the anchor and an end face of the fixed core,
the fuel injector that drives the armature by attracting the anchor to the fixed core by a magnetic attractive force generated between the end face of the anchor and the end face of the fixed core by the magnetic flux passing through the magnetic gap and pulls the seat valve apart from a valve seat to open a fuel path,
wherein
a through hole passing through the anchor from a face thereof facing the fixed core to an opposite side is formed in such a way that the through hole has a large-diameter portion and a small-diameter portion,
the large-diameter portion is located on a side where the fixed core is located with respect to the small-diameter portion, and
a central axis of the large-diameter portion is offset to the outer periphery of the anchor with respect to a central axis of the small-diameter portion.

2. The fuel injector according to claim 1, wherein
the fixed core has a tapered portion on the inner periphery of an end thereof facing the anchor.

3. The fuel injector according to claim 1, wherein
a ring-shaped collision projection is provided on the face of the anchor where the anchor faces the fixed core, and
the large-diameter portion of the through hole is disposed to divide the collision projection.

4. The fuel injector according to claim 3, wherein
the depth of the large-diameter portion of the through hole is in the range of 20 to 100 μm from a vertex of the ring-shaped collision projection provided on the face of the anchor where the anchor faces the fixed core.

5. The fuel injector according to claim 4, wherein
the center of the large-diameter portion and the center of the small-diameter portion are located on a straight line crossing a central axis of the anchor and extending in a radial direction.
